(19) United States
(12) Patent Application Publication
(10) Pub. No.: US 2006/0261732 A1
(43) Pub. Date: Nov. 23, 2006

(54) Color organic light-emitting diode display with improved lifetime

(75) Inventors: Michael E. Miller, Honeoye Falls, NY (US); Andrew D. Arnold, Hilton, NY (US)

Correspondence Address: Paul A. Leipold;Eastman Kodak Company, Patent Legal Staff, 343 State Street, Rochester, NY, 14650-2201, US

(73) Assignee: Eastman Kodak Company

(21) Appl. No.: 11/135,310

(22) Filed: May 23, 2005

(51) Int. Cl. H05B 33/00; H05B 33/02

(52) U.S. Cl. 313/504; 313/503

(57) ABSTRACT

An improved OLED color display device is disclosed, in which a display pixel has a plurality of light-emitting elements of different colors, wherein the areas of the light-emitting elements are different based on the emission efficiency of the light-emitting elements and the luminance stability over time of the light-emitting elements, thereby protecting the light-emitting elements whose emission efficiency or luminance stability is low from prematurely deteriorating, wherein the improvement comprises: the relative areas of the light-emitting elements being further based on a display usage profile including probabilities of different colors to be produced on the display during its lifetime, thereby further extending the useful lifetime of the display.

### FIELD OF THE INVENTION

The present invention relates to a color organic light-emitting diode (OLED) display having improved lifetime and to a method of designing such a display.

### BACKGROUND OF THE INVENTION

Recent advances in flat panel display technology have included the advent of flat panel displays that are constructed using Organic Light-emitting Diodes. This flat panel display technology has many advantages over flat panel displays based on more popular liquid crystal display technology. Unlike liquid crystal displays that use the orientation of liquid crystal materials to modulate light from a large uniform backlight, OLED displays utilize materials that emit light. A full-color display is typically constructed by depositing three different materials that each emits a different color of light onto a substrate to create a full-color display. Providing at least three different colors of light emissive elements allows the construction of a full-color display when the light from the three primary colors are integrated by the human eye. The fact that the human eye can integrate these colors and that the human eye has sensors that are sensitive to only three different wavelength bands, allow the perception of a large gamut of colors from these few primary colors. During the deposition of OLED materials to form OLED display devices, equal areas of each of the three primary colors are commonly deposited onto the substrate. Other OLED display configurations are also known in the prior art; including ones constructed using a single white light emissive area and a mechanism for performing color filtering.

Unfortunately, when equal area light-emitting elements of different materials are patterned to construct a display using the OLED materials available today, the lifetime of the display is often limited by the lifetime of one of the OLED materials. In a display formed from red, green and blue emissive materials, typically the blue OLED limits the lifetime of the display device. That is, when placed into a practical multicolor display, the time required for typical blue materials to deteriorate to produce half their original luminance is often only a fraction of the time required for typical green or red materials to deteriorate to the point that they produce half of their original luminance. For example, with one commonly available set of materials, the lifetime of the red light-emitting elements may be about 5.5 times as long as the lifetime of the blue emitting light-emitting elements, and the lifetime of the green light-emitting elements may be about 7 times as long as the lifetime of the blue light-emitting elements, when each material set is driven at currents required to produce a white with a standard color temperature. Similar problems can occur in devices employing a single emitter with color filters as the use of some color filter combinations may require either the red, green, or blue channel to be driven with a higher current density to achieve the desired white point. Under these circumstances, the light-emitting element with the highest required current density will deteriorate faster than the other light-emitting elements but the rate of accelerated decay will depend on other factors, such as the relative stability of the white light-emitting material over time and the conditions of use for each emitter.

Recent advances in OLED display devices have increased the complexity of this problem by adding additional light-emitting elements. Cok, et al in U.S. Pat. No. 6,570,584, published May 27, 2003 has discussed an OLED display having four or more primary colors to produce an OLED display device with a larger color gamut. Burroughes in U.S. Pat. No. 6,693,611, published Feb. 17, 2004 has discussed an OLED display device having four or more patterned emissive elements, producing an OLED display device having lower power consumption. Siwinski in US Patent Application 20020186214 published Dec. 12, 2002 has further discussed an OLED display device having a red, green, and blue emitter with an additional white emitter to provide a full-color display device with a monochromatic power savings mode. In any of these display devices, the designer has the ability to form a broad range of colors by applying different combinations of the four or more emitters. For example, a display designed with four emitters to minimize power consumption may form each color from the three most efficient primaries that may be used to produce the desired color. However a designer that is primarily concerned with image quality may wish to employ the maximum number of light-emitting elements to form any color to minimize artifacts such as banding or jaggies. The drive strategy that is employed by the display designer will influence the drive current provided to each of the light-emitting elements and therefore the rate at which each light-emitting element deteriorates. It is also important to note, however, that a display does not produce all colors with the same frequency and therefore, the proportion of time that the display is required to produce each color will also influence the rate at which each light-emitting element deteriorates.

To maintain a well-balanced, full-color display, it is important that the relative luminance of each of the different colored light-emitting elements be maintained throughout the lifetime of the display. If these relative luminance values change dramatically, images may have a serious color imbalance, and the user is likely to become dissatisfied with the display and consider the display to be at the end of its life, regardless of the overall luminance of the display. Some compensation can be made for the drop in the output of one or more light-emitting elements over time by continually increasing the current density through the lower luminance OLEDs. However, it is known that increasing current densities to drive a light-emitting element accelerates the luminance decay. Thus, the problem is actually worsened and the lifetime of the device before failure is further reduced. Alternatively, one may reduce the luminance of the red and green to balance the blue, but this lowers the overall brightness of the display. Once the display becomes too dim, the user may also consider the display to be at the end of its useful lifetime, regardless of the relative luminance of the different colored emitters. When only the luminance of the display is considered, one may maximize the useful lifetime of the display, by maximizing the time that the relative luminance of the different colored elements can be maintained while minimizing the loss of absolute luminance.

It should be noted that the way in which the display is used will have a significant effect on the relative lifetimes of the light-emitting elements.

For example, the luminance at which the display is driven may influence the rate of decay of each of the OLEDs in significantly different ways. Therefore, as is known in the prior art, it is important to account for the luminance at which the display will be driven to understand the rate of decay for each light-emitting element. It is also known in the art that the luminance of the display may not always be driven to the same value. For example, it is known in the art to use a sensor to detect ambient illumination level and to adjust the luminance of the display based upon that signal. This change in luminance will influence the relative lifetimes of the light-emitting elements. This aim luminance may further be adjusted on a longer term basis. For example, U.S. Pat. No. 6,456,016 issued Sep. 24, 2002 to Sundahl and Booth discuss an OLED in which peak white display luminance is maintained as a constant for a period of time and then gradually reduced as the display ages.

In an attempt to balance the lifetime of OLED display devices, flat panel displays with unequal areas of light-emitting material have been discussed by Kim et al. in US Patent Application 2002/0014837, published Feb. 7, 2002. Kim et al. discuss an OLED display in which the relative size of the red, green, and blue light-emitting elements are adjusted based on the luminous efficiency of the color materials employed in an OLED display. It is commonly known that the available red OLED materials have significantly lower luminous efficiency than the existing green and blue OLED materials. Because of the lower efficiency of existing red OLED materials, if one wishes to maintain sub-pixels of equal size, the power per square area that must be provided to the low luminous efficiency material must be increased to obtain the desired light output. Using this criterion, Kim et al. propose an OLED display with twice as much red light-emitting area as green and blue light-emitting area. By creating displays with relatively larger areas of red emitting materials than green or blue materials, the relative power per square area can be somewhat equalized across the different colored materials. However, optimizing the display layout suggested by Kim et al., does not necessarily lead one to a design in which the lifetimes of the three materials are optimized as many important factors; including the luminance stability of the materials over time, important optical characteristics of the target display design, changes in the aim luminance of the display device over time, the ability to transition energy to additional OLEDs or the image content to be presented on the display device, are not discussed by Kim et al.

U.S. Pat. No. 6,366,025 issued Apr. 2, 2002 to Yamada discloses an OLED display with unequal light-emitting element areas, wherein the area of the light-emitting elements are adjusted with the goal of improving the lifetime of the OLED display. Yamada considers the emission efficiency of the material, the chromaticity of each of the emissive materials and the chromaticity of the target display when attempting to determine the aim light emissive element areas. However, Yamada fails to discuss other important characteristics of OLED materials that will affect device lifetime, such as the differences in the inherent luminance stability over time of different materials. Yamada further does not consider important optical characteristics of the target display design, changes in the aim luminance of the display device over time, the ability to transition energy to additional OLEDs or the image content to be presented on the display device, each of which will influence the overall lifetime of OLED materials.

U.S. Pat. No. 6,747,618 issued Jun. 8, 2004 to Arnold, et al. discloses an improved OLED display device and design method wherein the lifetime of the OLED display device is improved by considering the emission efficiency of the emissive elements, the chromaticity of the target display white point and the relative luminance stability over time of the emissive materials when determining the relative areas of the light-emitting elements. However, since the display device will not be used to always display a white screen but will be used to display other information-bearing content, the lifetime of the display is not, necessarily optimized in the actual display application. Again, this patent application does not provide a means for selecting the relative areas of the light-emitting elements when four or more colored light-emitting elements are used to form the display, wherein multiple combinations of luminance from any of these light-emitting elements may be used to form any specified color.

US Patent Application 20040021423 published on Feb. 5, 2004 by Jongman et al. describes a display device in which the luminance of three different emitters are adjusted such that the lifetime of each of the different color of light-emitting elements have approximately equal half lives. Jongman recognizes that this goal may be accomplished by adjusting the relative areas of the different colors of light-emitting elements but also allows the color temperature of the peak display white to be varied to achieve the overall goal of balancing the lifetime of the different color channels. Jongman et al. once again does not consider important optical characteristics of the target display design, changes in the aim luminance of the display device over time, the ability to transition energy to additional OLEDs or the image content to be presented on the display device, each of which will influence the overall lifetime of OLED materials.

In each of the disclosed methods for optimizing the relative areas of the colored light-emitting elements, it is assumed that the relative areas of the different colored light-emitting elements required to optimize the lifetime of the display device when displaying peak white has a high correlation with the relative areas of the different colored light-emitting elements required to optimize the lifetime of the display device as it is employed during typical use. While this assumption might provide a reasonable approximation for three-color devices, this assumption is unlikely to be accurate for four or more color devices since peak white may be produced using only a subset of the light-emitting elements in these devices. For example, a display device having red, green, blue, and white light-emitting elements might produce the peak white of the display device by turning on only the white light-emitting element. Applying the methods described in the prior art by Kim et al., Yamada, Arnold et al. and Jongman et al. for this condition, it is obvious that the result will produce a display device having a white light-emitting element that is infinitely larger than the red, green, and blue light-emitting elements, making it impossible for the colored display device to produce colors other than white. Rather than assume that peak white is to be displayed in the methods known in the prior art, one might assume that the four emitters should be powered to each provide their peak luminance and the relative areas of the emitters and/or the chromaticity coordinate of the white point of the display adjusted to equal lifetime under these conditions. While this method will result in relative areas that may be physically realizable, this condition is also unlikely to produce relative areas that will be highly correlated with the relative areas that are likely to be required to optimize the lifetime of the display device in actual usage.

There is a need therefore for an improved method for determining the relative sizes of the light-emitting elements in an OLED display that compensates for the differences in lifetime of OLEDs within the display device when factors such as changing luminance values, image content, and/or the use of more than three OLEDs are applied, thereby providing a display with a truly longer lifetime.

### SUMMARY OF THE INVENTION

In accordance with one embodiment, the invention is directed towards an improved OLED color display device, in which a display pixel has a plurality of light-emitting elements of different colors, wherein the areas of the light-emitting elements are different based on the emission efficiency of the light-emitting elements and the luminance stability over time of the light-emitting elements, thereby protecting the light-emitting elements whose emission efficiency or luminance stability is low from prematurely deteriorating, wherein the improvement comprises: the relative areas of the light-emitting elements being further based on a display usage profile including probabilities of different colors to be produced on the display during its lifetime, thereby further extending the useful lifetime of the display.

In accordance with a further embodiment, the invention is directed towards a method of determining the relative areas of light-emitting elements in a OLED display device of the type having a display pixel that includes a plurality of light-emitting elements of different colors, comprising the steps of: determining a functional relationship between current density and luminance output for each light-emitting element; determining a functional relationship between current density and a luminance stability over time for each light-emitting element; determining a display usage profile for the display device including probabilities of different colors to be produced on the display during its lifetime; selecting an initial relative light emissive area for each color of light-emitting element; calculating a required luminance for each color of light-emitting element for each color within the display usage profile; calculating an aim current density for each light-emitting element for each color within the display usage profile to obtain the required luminance for each light-emitting element; calculating a lifetime for each light-emitting element for each color within the display usage profile using the aim current density and the luminance stability functions; calculating an overall lifetime for each colored light-emitting element based on the lifetime and probability for each color in the profile; and modifying the relative light emissive areas for each color of the light-emitting elements if the overall lifetimes are unequal, and repeating the calculating steps above until the lifetimes are substantially equal.

### ADVANTAGES

The present invention has the advantage of extending the useful lifetime of full-color OLED displays by taking into account a usage profile for the display device.

### BRIEF DESCRIPTION OF THE DRAWINGS

FIG. 1 is a schematic diagram showing a pixel having different sized light-emitting elements;

FIG. 2 is a flow chart of an iterative process used to determine relative light-emitting element areas according to the present invention;

FIG. 3 is schematic cross-sectional diagram of a typical prior art organic light-emitting display structure;

FIG. 4 is a schematic diagram showing a pixel having different colored light-emitting elements with different relative total areas for at least two colors;

FIG. 4 is a schematic top view of a display pixel in an OLED display apparatus according to an embodiment of the present invention in which the largest light-emitting element is divided into more than one light-emitting region;

FIG. 5 is a schematic top view of an OLED display apparatus according to an embodiment of the present invention in which multiple areas of he display device contain pixels having different relative light-emitting areas;

FIG. 6 is a graph useful in describing the present invention, showing the relationship between the luminance output and current density in OLED materials that emit red, green and blue light respectively; and

FIG. 7 is a graph useful in describing the present invention, showing the relationship between the material luminance stability over time and current density in OLED materials that emit red, green and blue light respectively.

FIG. 8 is a graph depicting the probability of occurrence for particular chrominance values for a display usage profile corresponding to a typical set of pictorial images.

### DETAILED DESCRIPTION OF THE INVENTION

The term “display device” is employed to designate a screen capable of electronically displaying video images or text. The term “pixel” is employed in its art-recognized usage to designate an element in a display device that can be addressed to form one part of a picture. The term “full-color” is employed to describe multicolor display devices that are capable of forming color images. Generally red, green, and blue color primaries constitute the three primary colors from which all other colors can be generated by appropriately mixing these three primaries. It is recognized that a “full-color” display may also be formed from more than three colors. The term “light-emitting element” is employed to designate any portion of a pixel that can be independently addressed to emit a specific color of light. For example, a blue light-emitting element is that portion of a pixel that can be addressed to emit blue light. In a full-color display, a pixel generally comprises at least three primary-color light-emitting elements, and these primary-color light-emitting elements typically emit blue, green, and red light. However, full-color displays may employ other combinations of three or more primaries.

The present invention is directed to a full-color OLED display in which the relative areas of the differently colored light-emitting elements are adjusted to improve the useful lifetime of the display device. This invention is achieved by adjusting the relative overall areas of each of the light-emitting elements on the display while taking into account a profile of display usage, in addition to other factors such as the luminance efficiencies and the luminance stability over time of the light-emitting materials that make up the light-emitting elements of the display to optimize the useful lifetime of the display. In the context used here, useful lifetime of the display refers to the number of hours in which the display can satisfy requirements such as display luminance output and/or white point stability.

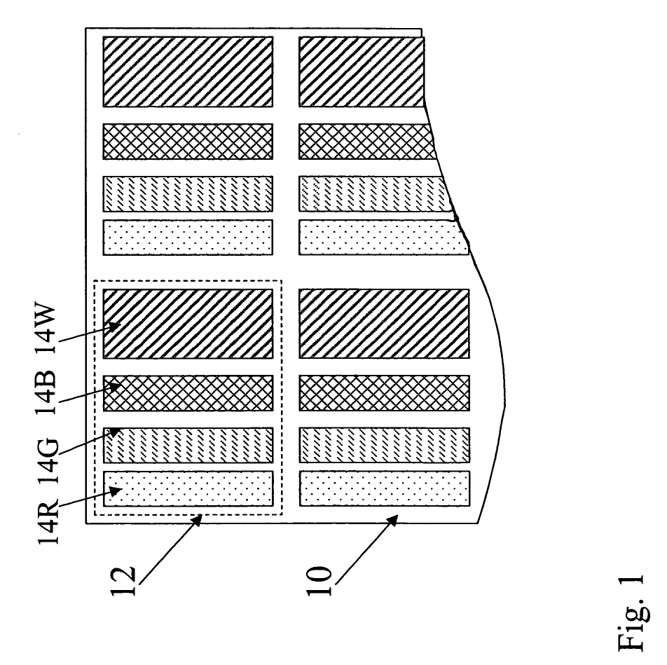

The present invention can be employed in most OLED device configurations. These include very simple structures comprising a single anode and cathode to more complex devices, such as passive matrix displays comprised of orthogonal arrays of anodes and cathodes to form pixels, and active-matrix displays where each pixel is controlled independently, for example, with a thin film transistor (TFT). For example, the structure described in U.S. Pat. No. 6,366,025 (which is incorporated herein by reference), may be employed to form an active matrix electroluminescent display device having light-emitting elements with relative sizes determined according to the present invention. FIG. 1 is a schematic diagram that shows a portion of a full-color OLED display device 10 having an array of pixels 12, each pixel 12 having four different colored light-emitting elements 14 of different sizes. The light-emitting elements 14 might emit any color of light but are labeled R, G, B and W representing red, green, blue, and white light-emitting elements respectively within this embodiment.

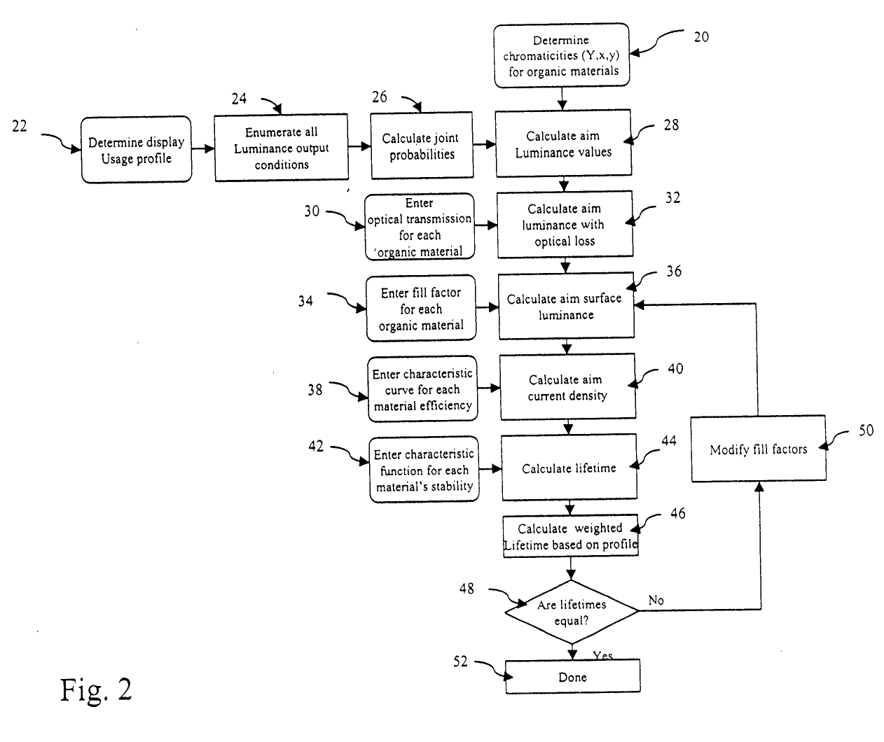

Referring to FIG. 2, the relative sizes of the red 14R, green 14G, blue 14B and white 14W light-emitting elements in the display device are determined according to one embodiment of the present invention by considering the chromaticity coordinates of the emitted light; the profile of display usage; the fill factors of the red, green, and blue light-emitting elements; the efficiency of the red, green, and blue light-emitting elements; the optical transmission characteristics of the light-emitting elements within the final display configuration, and the luminance stability over time of the organic materials.

The profile of display usage provides a description of the likely usage of the display device. In accordance with the invention, this profile includes probabilities of different colors to be produced on the display during its lifetime, such as in form of the probability of occurrence for each image signal value to be displayed (typically in the form of R, G, B code values). The usage profile may further include items such as the probability of occurrence for different peak white luminance values, the probability of occurrence for different display white points, a model for performing color conversion with probabilities for any parameters used in this conversion, a model for aging compensation, a description of further color processing, such as de-saturation, that may be used to extend the lifetime of the display with probabilities for the use of this color processing method or any other parameter that describes the conditions under which the display device will be driven.

The probability of occurrence for different peak white luminance values might include a table of different peak white luminance values and a probability of occurrence for each value. This data may be obtained based on intended use or might be derived by instrumenting similar devices with ambient sensors to understand the ambient illumination level that the device is likely to be used under and then performing a calculation to determine aim peak white luminance as a function of ambient illumination level. Similarly, the probability of occurrence for different white points may be determined based on intended use or the usage of a class of devices may be monitored to determine the probability for the use of different display white points.

The probability of occurrence for each image signal or code value to be displayed may also be based on intended use but it may also be derived by monitoring the use of typical display content and the proportion of time each screen of content or image is displayed and using this data to determine the probability of use for each code value during the lifetime of the display device. This probability may be determined in a spatially independent fashion, determining the probability of each code value a display is likely to display, averaged across the entire display. It may also be spatially dependent, providing a probability of any code value within a specified area or for each light-emitting element across the display device.

Other information within the display profile, such as a model for performing color conversion with probabilities for any parameters used in this conversion, a model for aging compensation, a model of further color processing, such as desaturation, may be used together with the usage profile to generate the probability for each light emitting element being driven to a particular luminance value.

To calculate the relative areas of the different colored light-emitting elements according to one embodiment of the present invention, the chromaticity coordinates and/or spectral emission of each of the different colored light-emitting materials are first determined 20. Next, the display usage profile is determined 22. The display usage profile may include one or more peak white luminance values with a probability of occurrence for each value, one or more display white points with a probability of occurrence for each value, the code values the display will be driven to as well as a probability for each code value determined and a model that provides a conversion from code value to aim display luminance. This conversion might include processing steps to provide a means to convert from a three-color input signal to a four or more color signal. Algorithms for conversion from three to four or more colors such as those described in copending, commonly assigned U.S. Ser. No. 10/607,374 (filed Jun. 26, 2003), Ser. No. 10/812,787 (filed Mar. 29, 2004) and Ser. No. 10/812,787 (filed Mar. 29, 2004), the disclosures of which are incorporated herein by reference, may be employed, e.g., to complete this conversion. On any display, this conversion method might include other standard image processing steps, such as color mapping, desaturation, sharpening, and gamma correction. If any of these methods are to be used, they should be as mathematically similar to the actual algorithms that will be implemented to drive the display device as is possible. It may also be noted that these methods may not always be applied in the same way for every image but instead might be applied under certain conditions and the occurrence of these conditions may be described using a probabilistic model. For example, one might apply desaturation while in a graphics mode but not apply it while operating in a pictorial mode. Monitoring usage in similar devices or through engineering judgment may be used to derive probabilities for the use of these modes. In another example, parameters within the algorithms for providing conversion from three to four or more colors might be varied as a function of the state of the display device or as a function of image content.

Using this display usage profile, a list of all usage conditions together are enumerated 24 by combining all of the appropriate conditions in a factorial fashion. For example, if a display is designed to employ two peak luminance values then these two peak luminance values are factorially combined with all code value combinations to form the enumerated list of usage conditions. Joint probabilities are then calculated 26 for each usage condition within the enumerated list such that the probability of each code value at each luminance is known.

The aim luminance required from each light emissive element is then calculated 28 for each usage condition (e.g., white point, luminance, code value, and color conversion method). This step employs each algorithm as if it were embedded within a display system to calculate the aim luminance that is intended to be produced by the display device for each of the usage conditions.

An optical transmission factor is then determined 30 for each light-emitting element in the display device. This optical transmission factor indicates the proportion of the luminance that will be emitted by the display by each light-emitting element. The optical transmission factor may include factors such as absorptions that take place within a polarizer or other layers within the display device structure and reflections that occur at the interface between different optical layers within the display device structure. The luminance values for each of the color light-emitting elements are then calculated 32 for each color light-emitting element within each usage condition by multiplying the previously calculated 28 aim luminance values by the inverse of this proportion to determine the aim luminance for each light-emitting element before unwanted absorptions.

An initial fill factor for light-emitting elements of each color is then selected 34. These fill factors are the proportion of the total pixel area that will emit light of the light-emitting elements of each color. The necessary surface luminance value for each color light-emitting element within each of the usage conditions is then calculated 36 by multiplying the luminance value determined in 32 by the fill factor.

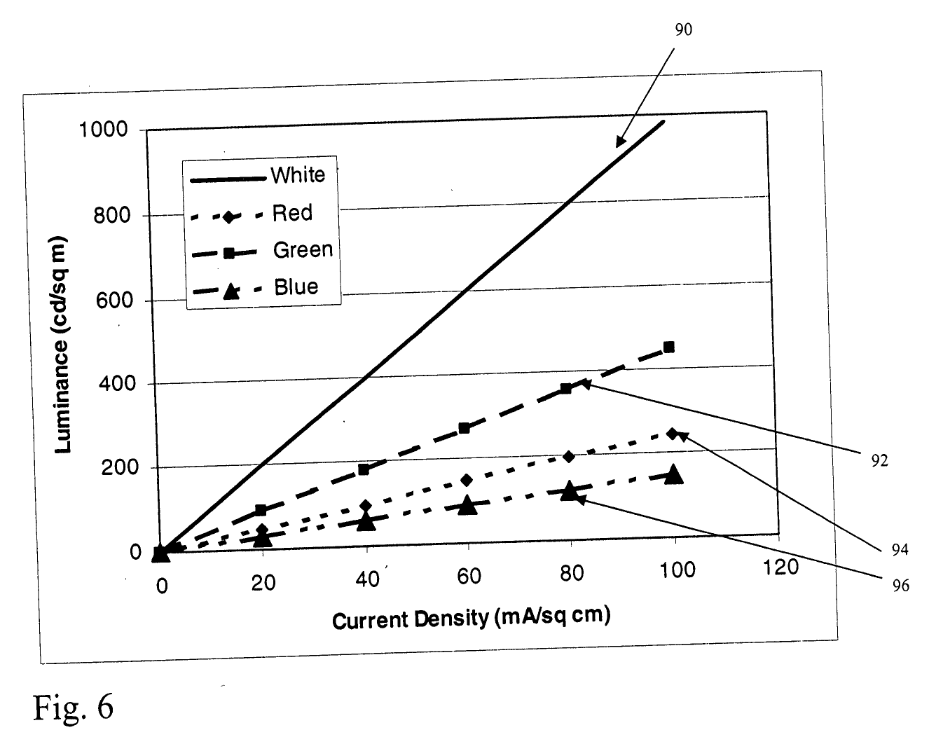

Characteristic curves relating output luminance to input current density (see FIG. 6) is then entered 38 for the light-emitting materials employed in each colored light-emitting element. For most OLED materials, this characteristic curve will be a linear function that allows the current density to be calculated as a function of luminance. These functions may be of the form:
I=(L−b)/a, (4)
where: I represents the current density required to drive each light-emitting element; L represents the surface luminance that was previously calculated; and a and b are constants that differ for each light-emitting material. These functions are then used to calculate 40 the aim current density required to drive each light-emitting element to display the selected aim chromaticity and luminance for each unique usage condition (e.g., display luminance, white point, code value, and color conversion method).

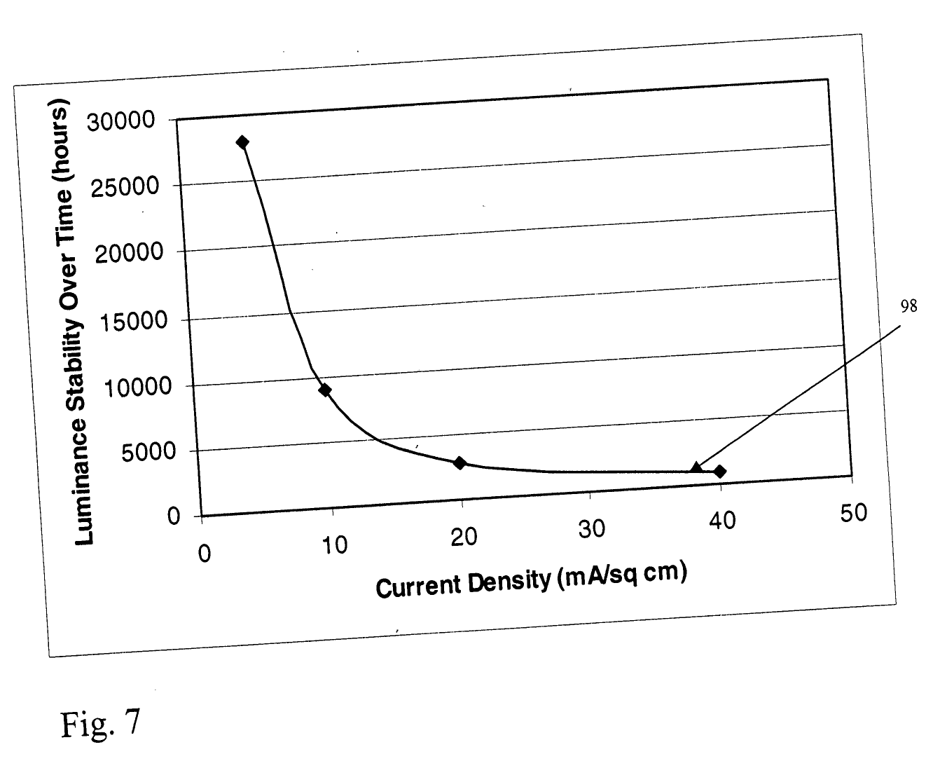

Characteristic curves relating current density to the luminance stability over time of the light-emitting materials (see FIG. 7) are then determined 42 for the materials employed in each light-emitting element. For example, a power function of the form:
T=cI^{d} (5)
may be used to estimate the time until the light-emitting element has lost half its original luminance where T is the time and c and d are constants that are different for each different material. These characteristic curves are determined empirically by measuring the light output from test pixels that are produced using the processes that will be employed to manufacture the display device. These characteristic functions may then be used to calculate 44 the useful lifetime of each color light-emitting element within the display device for each unique usage condition.

The overall lifetime of each light-emitting element is then calculated 46 by computing a weighted average of all of the lifetime values by applying the following equation:

$${L}_{A} = {\sum }_{i = 1}^{n} ( \frac{{p}_{i}}{{T}_{i}} )$$

L_{A} is the average lifetime for each light-emitting element, n is the number of display usage conditions, i is the current display usage condition, pi is the joint probability that was determined in step 26 for display usage condition i, and Tᵢ is the time that would be required for the display device to attain the defined end of life as calculated in step 44.

Once these useful lifetime values are calculated for all light-emitting elements, a decision 48 is made based upon whether the useful lifetimes are substantially equal (within a predetermined tolerance) for the all of the different color of light-emitting elements. If the useful lives are not equal, the fill factors for the different colored light-emitting elements are modified 50, reducing the area of the light-emitting elements with the larger useful lives and increasing the area of the light-emitting elements with the smaller useful lives. The calculations 36, 40, 42, and 44 are performed again with the altered light-emitting element areas. If the values are equal to one another, the process is complete 52 and the aim fill factor for the display is used to determine the final relative sizes of the different colored light-emitting elements.

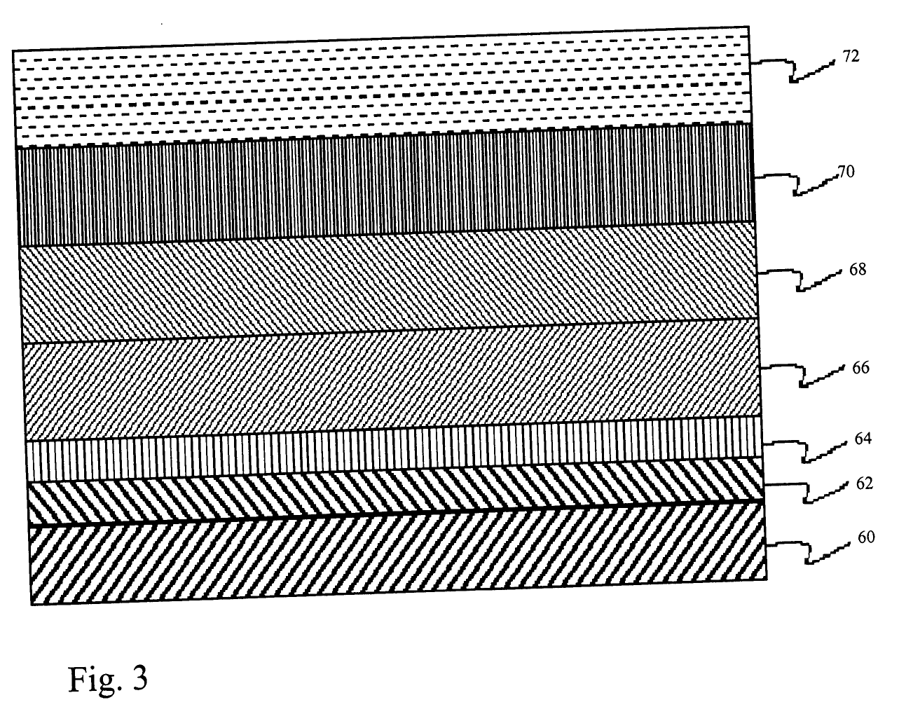

There are numerous configurations of the organic layers wherein the present invention can be successfully practiced. A typical prior art structure is shown in FIG. 3 and is comprised of a substrate 60, an anode layer 62, a hole-injecting layer 64, a hole-transporting layer 66, a light-emitting layer 68, an electron-transporting layer 70, and a cathode layer 72. These layers are described in detail below. Note that the substrate may alternatively be located adjacent to the cathode, or the substrate may actually constitute the anode or cathode. The organic layers between the anode and cathode are conveniently referred to as the organic EL element. The total combined thickness of the organic layers is preferably less than 500 nm.

The OLED device of this invention is typically provided over a supporting substrate 60 where either the cathode or anode can be in contact with the substrate. The electrode in contact with the substrate is conveniently referred to as the bottom electrode. Conventionally, the bottom electrode is the anode, but this invention is not limited to that configuration. The substrate can either be light transmissive or opaque, depending on the intended direction of light emission. The light transmissive property is desirable for viewing the EL emission through the substrate. Transparent glass or plastic is commonly employed in such cases. For applications where the EL emission is viewed through the top electrode, the transmissive characteristic of the bottom support is immaterial, and therefore can be light transmissive, light absorbing or light reflective. Substrates for use in this case include, but are not limited to, glass, plastic, semiconductor materials, silicon, ceramics, and circuit board materials. Of course it is necessary to provide in these device configurations a light-transparent top electrode.

When EL emission is viewed through the anode 62, the, anode should be transparent or substantially transparent to the emission of interest, otherwise any metal or electrically conducting material may be applied. Common transparent anode materials used in this invention are indium-tin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode. For applications where EL emission is viewed only through the cathode electrode, the transmissive characteristics of anode are immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means. Anodes can be patterned using well-known photolithographic processes.

It is often useful to provide a hole-injecting layer 64 between anode 62 and hole-transporting layer 66. The hole-injecting material can serve to improve the film formation property of subsequent organic layers and to facilitate injection of holes into the hole-transporting layer. Suitable materials for use in the hole-injecting layer include, but are not limited to, porphyrinic compounds as described in U.S. Pat. No. 4,720,432, and plasma-deposited fluorocarbon polymers as described in U.S. Pat. No. 6,208,075. Alternative hole-injecting materials reportedly useful in organic EL devices are described in EP 0 891 121 A1 and EP 1 029 909 A1.

The hole-transporting layer 66 contains at least one hole-transporting compound such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. in U.S. Pat. No. 3,180,730. Other suitable triarylamines substituted with one or more vinyl radicals and/or comprising at least one active hydrogen containing group are disclosed by Brantley et al. in U.S. Pat. Nos. 3,567,450 and 3,658,520.

A more preferred class of aromatic tertiary amines are those which include at least two aromatic tertiary amine moieties as described in U.S. Pat. Nos. 4,720,432 and 5,061,569. The hole-transporting layer can be formed of a single or a mixture of aromatic tertiary amine compounds. Illustrative of useful aromatic tertiary amines are the following:

1,1-Bis(4-di-p-tolylaminophenyl)cyclohexane

1,1-Bis(4-di-p-tolylaminophenyl)-4-phenylcyclohexane

4,4′-Bis(diphenylamino)quadriphenyl

Bis(4-dimethylamino-2-methylphenyl)-phenylmethane

N,N,N-Tri(p-tolyl)amine

4-(di-p-tolylamino)-4′-[4(di-p-tolylamino)-styryl]stilbene

N,N,N′,N′-Tetra-p-tolyl-4-4′-diaminobiphenyl

N,N,N′,N′-Tetraphenyl-4,4′-diaminobiphenyl

N,N,N′,N′-tetra-1-naphthyl-4,4′-diaminobiphenyl

N,N,N′,N′-tetra-2-naphthyl-4,4′-diaminobiphenyl

N-Phenylcarbazole

4,4′-Bis[N-(1-naphthyl)-N-phenylamino]biphenyl

4,4′-Bis[N-(1-naphthyl)-N-(2-naphthyl)amino]biphenyl

4,4″-Bis[N-(1-naphthyl)-N-phenylamino]p-terphenyl

4,4′-Bis[N-(2-naphthyl)-N-phenylamino]biphenyl

4,4′-Bis[N-(3-acenaphthenyl)-N-phenylamino]biphenyl

1,5-Bis[N-(1-naphthyl)-N-phenylamino]naphthalene

4,4′-Bis[N-(9-anthryl)-N-phenylamino]biphenyl

4,4″-Bis[N-(1-anthryl)-N-phenylamino]-p-terphenyl

4,4′-Bis[N-(2-phenanthryl)-N-phenylamino]biphenyl

4,4′-Bis[N-(8-fluoranthenyl)-N-phenylamino]biphenyl

4,4′-Bis[N-(2-pyrenyl)-N-phenylamino]biphenyl

4,4′-Bis[N-(2-naphthacenyl)-N-phenylamino]biphenyl

4,4′-Bis[N-(2-perylenyl)-N-phenylamino]biphenyl

4,4′-Bis[N-(1-coronenyl)-N-phenylamino]biphenyl

2,6-Bis(di-p-tolylamino)naphthalene

2,6-Bis[di-(1-naphthyl)amino]naphthalene

2,6-Bis[N-(1-naphthyl)-N-(2-naphthyl)amino]naphthalene

N,N,N′,N′-Tetra(2-naphthyl)-4,4″-diamino-p-terphenyl

4,4′-Bis {N-phenyl-N-[4-(1-naphthyl)-phenyl]amino}biphenyl

4,4′-Bis[N-phenyl-N-(2-pyrenyl)amino]biphenyl

2,6-Bis[N,N-di(2-naphthyl)amine]fluorene

1,5-Bis[N-(1-naphthyl)-N-phenylamino]naphthalene

Another class of useful hole-transporting materials includes polycyclic aromatic compounds as described in EP 1 009 041. In addition, polymeric hole-transporting materials can be used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS.

As more fully described in U.S. Pat. Nos. 4,769,292 and 5,935,721, the light-emitting layer (LEL) 68 of the organic EL element includes a luminescent or fluorescent material where electroluminescence is produced as a result of electron-hole pair recombination in this region. The light-emitting layer can be comprised of a single material, but more commonly consists of a host material doped with a guest compound or compounds where light emission comes primarily from the dopant and can be of any color. The host materials in the light-emitting layer can be an electron-transporting material, as defined below, a hole-transporting material, as defined above, or another material or combination of materials that support hole-electron recombination. The dopant is usually chosen from highly fluorescent dyes, but phosphorescent compounds, e.g., transition metal complexes as described in WO 98/55561, WO 00/18851, WO 00/57676, and WO 00/70655 are also useful. Dopants are typically coated as 0.01 to 10% by weight into the host material. Polymeric materials such as polyfluorenes and polyvinylarylenes (e.g., poly(p-phenylenevinylene), PPV) can also be used as the host material. In this case, small molecule dopants can be molecularly dispersed into the polymeric host, or the dopant could be added by copolymerizing a minor constituent into the host polymer.

An important relationship for choosing a dye as a dopant is a comparison of the bandgap potential which is defined as the energy difference between the highest occupied molecular orbital and the lowest unoccupied molecular orbital of the molecule. For efficient energy transfer from the host to the dopant molecule, a necessary condition is that the band gap of the dopant is smaller than that of the host material.

Host and emitting molecules known to be of use include, but are not limited to, those disclosed in U.S. Pat. Nos. 4,769,292; 5,141,671; 5,150,006; 5,151,629; 5,405,709; 5,484,922; 5,593,788; 5,645,948; 5,683,823; 5,755,999; 5,928,802; 5,935,720; 5,935,721; and 6,020,078.

Metal complexes of 8-hydroxyquinoline (oxine) and similar derivatives constitute one class of useful host compounds capable of supporting electroluminescence. Illustrative of useful chelated oxinoid compounds are the following:

CO-1: Aluminum trisoxine [alias, tris(8-quinolinolato)aluminum(III)]

CO-2: Magnesium bisoxine [alias, bis(8-quinolinolato)magnesium(II)]

CO-3: Bis[benzo {f}-8-quinolinolato]zinc (II)

CO-4: Bis(2-methyl-8-quinolinolato)aluminum(III)-μ-oxo-bis(2-methyl-8-quinolinolato)aluminum(III)

CO-5: Indium trisoxine [alias, tris(8-quinolinolato)indium]

CO-6: Aluminum tris(5-methyloxine) [alias, tris(5-methyl-8-quinolinolato)aluminum(III)]

CO-7: Lithium oxine [alias, (8-quinolinolato)lithium(I)]

CO-8: Gallium oxine [alias, tris(8-quinolinolato)gallium(III)]

CO-9: Zirconium oxine [alias, tetra(8-quinolinolato)zirconium(IV)]

Other classes of useful host materials include, but are not limited to: derivatives of anthracene, such as 9,10-di-(2-naphthyl)anthracene and derivatives thereof, distyrylarylene derivatives as described in U.S. Pat. No. 5,121,029, and benzazole derivatives, for example, 2,2′,2″-(1,3,5-phenylene)tris[1-phenyl-1H-benzimidazole].

Useful fluorescent dopants include, but are not limited to, derivatives of anthracene, tetracene, xanthene, perylene, rubrene, coumarin, rhodamine, quinacridone, dicyanomethylenepyran compounds, thiopyran compounds, polymethine compounds, pyrilium and thiapyrilium compounds, fluorene derivatives, periflanthene derivatives and carbostyryl compounds. Electron-Transporting Layer (ETL)

Preferred thin film-forming materials for use in forming the electron-transporting layer 70 of the organic EL elements of this invention are metal chelated oxinoid compounds, including chelates of oxine itself (also commonly referred to as 8-quinolinol or 8-hydroxyquinoline). Such compounds help to inject and transport electrons, exhibit high levels of performance, and are readily fabricated in the form of thin films. Exemplary oxinoid compounds were listed previously.

Other electron-transporting materials include various butadiene derivatives as disclosed in U.S. Pat. No. 4,356,429 and various heterocyclic optical brighteners as described in U.S. Pat. No. 4,539,507. Benzazoles and triazines are also useful electron-transporting materials.

In some instances, layers 70 and 68 can optionally be collapsed into a single layer that serves the function of supporting both light emission and electron transport. These layers can be collapsed in both small molecule OLED systems and in polymeric OLED systems. For example, in polymeric systems, it is common to employ a hole-transporting layer such as PEDOT-PSS with a polymeric light-emitting layer such as PPV. In this system, PPV serves the function of supporting both light emission and electron transport.

When light emission is viewed solely through the anode, the cathode 72 used in this invention can be comprised of nearly any conductive material. Desirable materials have good film-forming properties to ensure good contact with the underlying organic layer, promote electron injection at low voltage, and have good luminance stability over time. Useful cathode materials often contain a low work function metal (<4.0 eV) or metal alloy. One preferred cathode material is comprised of a Mg:Ag alloy wherein the percentage of silver is in the range of 1 to 20%, as described in U.S. Pat. No. 4,885,221. Another suitable class of cathode materials includes bilayers comprising a thin electron-injection layer (EIL) in contact with the organic layer (e.g., ETL), which is capped with a thicker layer of a conductive metal. Here, the EIL preferably includes a low work function metal or metal salt, and if so, the thicker capping layer does not need to have a low work function. One such cathode is comprised of a thin layer of LiF followed by a thicker layer of Al as described in U.S. Pat. No. 5,677,572. Other useful cathode material sets include, but are not limited to, those disclosed in U.S. Pat. Nos. 5,059,861; 5,059,862, and 6,140,763.

When light emission is viewed through the cathode, the cathode must be transparent or nearly transparent. For such applications, metals must be thin or one must use transparent conductive oxides, or a combination of these materials. Optically transparent cathodes have been described in more detail in U.S. Pat. No. 4,885,211, U.S. Pat. No. 5,247,190, JP 3,234,963, U.S. Pat. No. 5,703,436, U.S. Pat. No. 5,608,287, U.S. Pat. No. 5,837,391, U.S. Pat. No. 5,677,572, U.S. Pat. No. 5,776,622, U.S. Pat. No. 5,776,623, U.S. Pat. No. 5,714,838, U.S. Pat. No. 5,969,474, U.S. Pat. No. 5,739,545, U.S. Pat. No. 5,981,306, U.S. Pat. No. 6,137,223, U.S. Pat. No. 6,140,763, U.S. Pat. No. 6,172,459, EP 1 076 368, and U.S. Pat. No. 6,278,236. Cathode materials are typically deposited by evaporation, sputtering, or chemical vapor deposition. When needed, patterning can be achieved through many well known methods including, but not limited to, through-mask deposition, integral shadow masking as described in U.S. Pat. No. 5,276,380 and EP 0 732 868, laser ablation, and selective chemical vapor deposition.

The organic materials mentioned above are suitably deposited through a vapor-phase method such as sublimation, but can be deposited from a fluid, for example, from a solvent with an optional binder to improve film formation. If the material is a polymer, solvent deposition is useful but other methods can be used, such as sputtering or thermal transfer from a donor sheet. The material to be deposited by sublimation can be vaporized from a sublimator “boat” often comprised of a tantalum material, e.g., as described in U.S. Pat. No. 6,237,529, or can be first coated onto a donor sheet and then sublimed in closer proximity to the substrate. Layers with a mixture of materials can utilize separate sublimator boats or the materials can be pre-mixed and coated from a single boat or donor sheet. Patterned deposition can be achieved using shadow masks, integral shadow masks (U.S. Pat. No. 5,294,870), spatially-defined thermal dye transfer from a donor sheet (U.S. Pat. Nos. 5,851,709 and 6,066,357) and inkjet method (U.S. Pat. No. 6,066,357).

Most OLED devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890. In addition, barrier layers such as SiOx, Teflon, and alternating inorganic/polymeric layers are known in the art for encapsulation.

OLED devices of this invention can employ various well-known optical effects in order to enhance its properties if desired. This includes optimizing layer thicknesses to yield maximum light transmission, providing dielectric mirror structures, replacing reflective electrodes with light-absorbing electrodes, providing anti glare or anti-reflection coatings over the display, providing a polarizing medium over the display, or providing colored, neutral density, or color conversion filters over the display. Filters, polarizers, and anti-glare or anti-reflection coatings may be specifically provided over the cover or as part of the cover.

In addition to the device architecture described above, each organic EL element may be comprised of a series of organic stacks as described in U.S. Pat. No. 6,872,472, which is incorporated herein by reference.

While this implementation has been described with respect to an OLED display constructed of different red, green, blue and white light-emitting materials, one skilled in the art will recognize that this same display configuration and process can be applied to the construction of an OLED display employing fewer light-emitting materials in combination with a mechanism for filtering the emission of the light-emitting materials. However, when employing color filters, the chromaticity coordinates of each color light-emitting element and the luminance of each color of light-emitting material as it contributes to the overall display luminance and chromaticity must be calculated by determining the spectral radiance of the light-emitting materials across the visible spectrum, multiplying these spectra by the transmission of each of the color filter elements at each wavelength, and transforming the resulting spectral values to standardized luminance and chromaticity coordinates using standard CIE conventions.

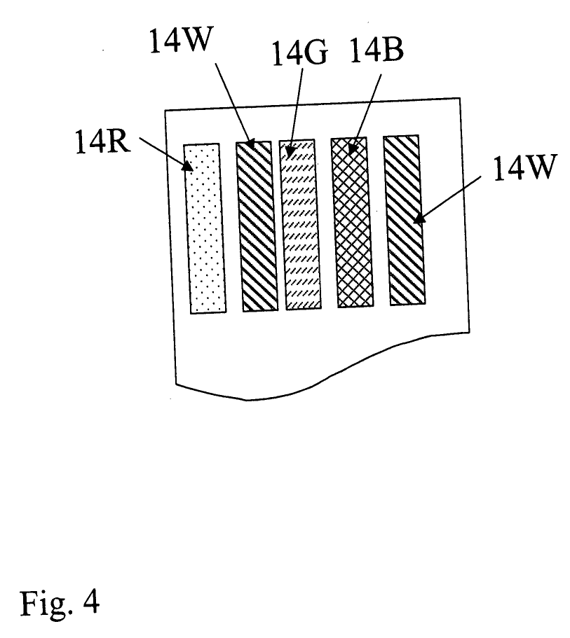

According to an alternative embodiment of the present invention individually addressable light-emitting elements may be further divided into spatially distinct regions. Such an embodiment is shown in FIG. 4 where the colored light-emitting element with the largest area (e.g. the white light-emitting element 14W) is divided into two spatially distinct regions. In this example, the red light-emitting element 14R, green light-emitting element 14G and blue light-emitting element 14B are each composed of a single region. In this embodiment, the spatial pattern of the array of white light-emitting elements 14W becomes visually less noticeable when viewing the display from a normal viewing distance, thereby improving the perceived quality of the display while providing improved lifetime according to the present invention.

In a further embodiment of the present invention the relative areas of the light-emitting elements are achieved by stacking multiple light-emitting layers with adjoining connector layers between the anode and cathode as described in U.S. Pat. No. 6,872,472. In other words, providing two stacks of a series light-emitting units (e.g., light-emitting layers, possibly with hole transport electron transport layers) effectively doubles the area of the light-emitting element by providing vertically stacked layers of light emitting materials. According to this embodiment, unequal numbers of light-emitting layers may be deposited for different light-emitting elements, and either equal or unequal numbers of light-emitting layers may be further combined with unequal areas to achieve the relative light-emitting element areas calculated according to the present invention.

According to a still further embodiment of the present invention a larger area for the light-emitting material may be provided within a stacked OLED display of the type described in U.S. Pat. No. 6,358,631. When such a device employing separately controllable stacked light-emitting elements is employed in the present invention, each separately controllable light-emitting element in the stack may itself be further comprised of multiple light-emitting layer units, each element formed between a pair of electrodes and more than one of the light emitting layer units providing light of substantially the same color as described in U.S. Pat. No. 6,872,472. This would enable further increases in the overall area of the light-emitting material and reduce the current density per unit area. As stated before, the relative sizes of the areas of the light-emitting elements of different colors are determined based on the process shown in FIG. 2 as described earlier. It should be recognized that this same embodiment may further be modified to contain multiple light emissive layers within the first, second, and/or third light-emitting element as described above.

In all of the embodiments described thus far it has been assumed that the display usage profile is independent of the spatial location on the display device. However, it is typical that certain areas of a display device are reserved for certain types of information to allow a more consistent user interface and to facilitate enhanced search and retrieval of information of the display user. For example, the user interface of a PDA being run by Windows CE typically contains a blue title bar at the top of the display device while much of the remainder of the user interface will display more neutral whites and grays. If this information is present on the display device a substantial proportion of the time and the display device is designed such that spatial dependence is not considered, the blue light-emitting elements in the title bar of the display device will likely deteriorate faster than within this region of the display device than the blue light-emitting elements at other locations on the display device. This limitation may be overcome by designing the display device to have different relative areas for the light-emitting elements of different colors as a function of their spatial location.

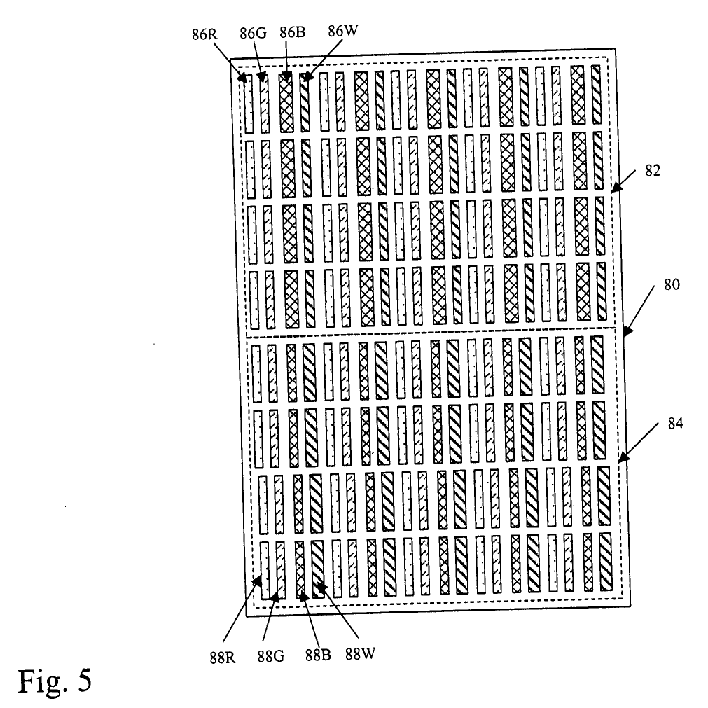

One possible embodiment of such a display device is depicted in FIG. 5. As shown, in such a display device 80, the relative aperture ratios of the different color light-emitting elements may be adjusted to vary as a function of screen location. FIG. 5 depicts such a display device composed of two areas 82 and 84, each area composed of light-emitting elements with different relative aperture ratios. Assuming that the top region 82 of the display device 80 is typically used to display predominantly blue information, the relative light-emitting element aperture ratios will have one set of values. As shown, the blue light-emitting element 86B is larger than the red 86R, green 86G or white 86W light-emitting elements. However in the lower region 84 that is assumed to display more neutral information, the light-emitting element aperture ratios will have a second set of values. As shown, the white light-emitting element 88W has a larger area than the red 88R, green 88G and blue 88B light-emitting elements. The actual light-emitting element aperture ratios may be determined to maximize the lifetime of the display device by employing a spatially dependent display profile. In such a profile, information such as the white point of the display, peak luminance, code value distribution, and/or rendering method may vary as a function of the spatial position on the display device. This spatial position may vary as a function of different regions within a display device or even individual pixels within the display device. The weighted average computation 46 is then performed for each spatial region or pixel on the display device.

It should be noted that while the invention described herein may be applied to OLEDs having fewer light-emitting elements, it will be particularly useful in OLED devices having four or more different colored light-emitting elements, such as a device employing three primary colored light-emitting elements and a fourth white-light emitting element. While methods of the prior art typically attempt to determine the relative aperture ratios of the light-emitting elements when forming the color white, in a four or more color display device, any color can be formed in any number of ways and the way in which each color is formed can have a large effect on the desired relative light-emitting element aperture ratio. By way of example, if we assume that a display has red, green, and blue light-emitting elements as well as a white light-emitting element that emits light at the white point of the display device, one can make white by using any linear combination of the light produced by a combination of the red, green and blue light-emitting elements that are balanced to the white point of the display and the light produced by the white light-emitting element. Without understanding how frequently white is to be made from either of these sets of light-emitting elements, one could allow the white light-emitting element to have 100% fill factor, which would form a display without red, green or blue light-emitting elements or to form a display device without any white light-emitting element. 6Use of a display profile as described within this disclosure provides a deterministic solution to this problem, and is therefore most useful in displays having more than three light-emitting elements.

### EXAMPLE 1

### Comparative

To further demonstrate the difference between the system and method described herein from the prior art, an example is provided. Within this example, it is assumed that the lifetime is defined as the number of hours required for any of the color light-emitting elements to decay to 50% of their original luminance. To utilize this method, it is important to establish the specific efficiencies and luminance stabilities over time of the materials from which the display is to be built as well as to establish the aim characteristics of a display.

In this example, it is assumed that the display device to be constructed will utilize a common white light-emitting material and employ color filters to create color. Further the display device will have four light-emitting elements per pixel, including light-emitting elements that are filtered with red, green and blue color filters as well as a white light-emitting element that has no color filter.

It is further assumed that one or more OLED test cells are available that have been prepared using the light-emitting material to be used in the display. These test cells are driven and configured as similarly to the final display as possible. The characteristic curves for each light-emitting element required for step 38 are then determined by driving the test cells to a series of different current densities and measuring the radiant energy as a function of wavelength for each test cell. The luminance and power are calculated from the measured values to determine luminance efficiency and these values are averaged across multiple test cells to determine the average luminance efficiency of these test cells at each current density. The resulting function serves as the characteristic curve for the unfiltered white light-emitting element. Although these values must be measured for each emitting material, the values for filtered primaries may be calculated based on knowing only the emission of the white element. The characteristic curves for the red, green, and blue light-emitting elements are adjusted to their correct values by determining the luminance of the source before and after it is passed through each colored filter and then adjusting the measured luminance efficiency values by this factor to determine the luminance efficiency of each primary. This correction factor is determined by convolving the spectral transmission of each color filter with the radiant energy of the white emitting material as a function of wavelength, which produces the spectral output of the emitter after it is passed through the color filter, computing the luminance before and after the color filter and using the proportion of luminance after the filter to the luminance before the filter to adjust the measured efficiency value. An equation is then fit to this data to determine the efficiency curve for each light-emitting element. Sample data sets for white 90, as well as filtered green 92, red 94, and blue 96 characteristic curves are shown in FIG. 6 for a representative set of color filters and an example light-emitting material. FIG. 6 additionally shows a linear fit to each curve. The linear fits shown in this figure can be described using the slopes and offsets for material efficiencies shown in Table 1 below.

The luminance stability over time of each light-emitting element required for step 42 may then be determined by selecting a subset of the test cells for the light-emitting material and driving them with a single current density while measuring the luminance decay of the material over time. Once again, the average performance may be determined from a group of test cells that were prepared using the same light emissive materials and driven and configured as similarly to the final display as possible. A sample data set and power function fit characteristic curve 98 to this data are shown in FIG. 7. The multiplication and exponential factors for these equations that characterize luminance stability over time are shown in Table 1 below.

TABLE 1

| | White Light- |
|---|---|
| Characteristic | emitting Material |
| Slope for efficiency equation | 9.8 |
| Intercept for efficiency equation | 0.0 |
| Multiplication factor for the luminance | 396122 |
| stability equation | |
| Power for luminance stability equation | −1.6459 |

The CIE chromaticity coordinates needed for step 20 for each emitter is then computed by convolving the spectral radiance data with the spectral transmission of the red, green and blue color filters as well as the spectral transmission of any other optical element that provides a non-uniform filtering of the radiant spectrum and then performing standard calculations to determine CIE x,y chromaticity coordinates for each emitter. These chromaticity coordinates are shown in Table 2.

TABLE 2

| | x chromaticity | y chromaticity |
|---|---|---|
| | coordinate | coordinate |
| White Emission | 0.3226 | 0.3169 |
| Red Filtered Emission | 0.6573 | 0.3364 |
| Green Filtered Emission | 0.2545 | 0.5525 |
| Blue Filtered Emission | 0.1137 | 0.1406 |

Table 3 lists the characteristics of an example display that is to be constructed. In this example, conditions such as the peak luminance, chromaticity coordinates for the display white point, pixel fill factor and optical transmission factor for light after it passes through the color filters are provided.

TABLE 3

| Display Characteristic | Value |
|---|---|
| Peak Display Luminance | 100 cd/sq m |
| x chromaticity coordinate for white | 0.3127 |
| y chromaticity coordinate for white | 0.3290 |
| Fill factor | 0.44 |
| Optical Transmission Factor | 0.50 |

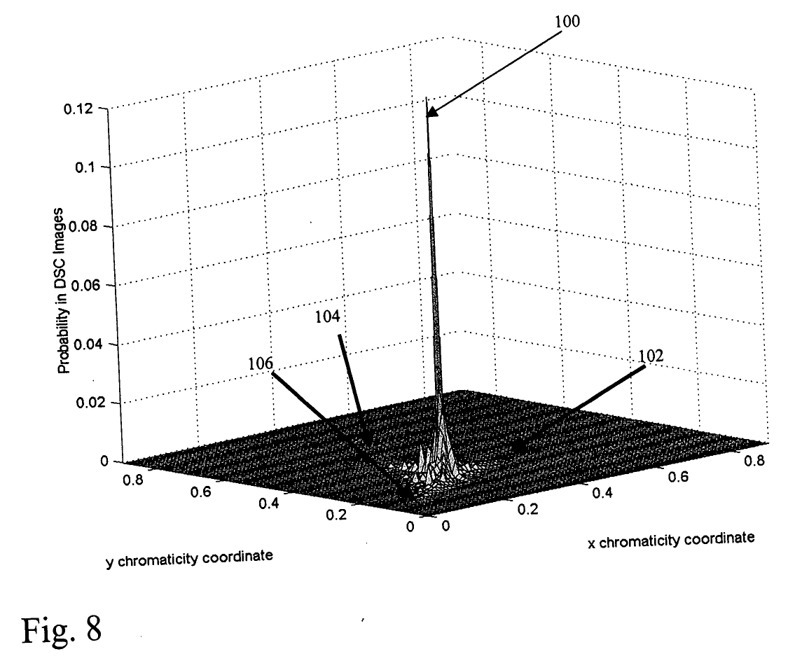

To employ the current invention, a display usage profile is determined 22. The display usage profile for this example employs a set of data representing the probability of occurrence for each color value in a typical set of pictorial images, such as might be displayed on a display device that is to be employed on the back of a digital camera. The chrominance portion of this probability data is depicted in FIG. 8, which shows the probability of occurrence as a function of x and y chromaticity value (without depicting relative luminance). Note that this figure shows that colors near neutral 100 occur with much higher frequency than more saturated colors, such as saturated reds 102, greens 104, and blues 106. Although display usage profiles employed in accordance with the invention may contain more information as indicated earlier, for this example we employ a usage profile consisting of this probability data and a color conversion algorithm of the class described in co-pending, commonly assigned U.S. Ser. No. 10/607,374 (filed Jun. 26, 2003) incorporated by reference above, employing a white mixing value of 1.0 (i.e., where the white light-emitting element in each pixel is employed to provide the maximum proportion of desired pixel luminance without changing desired pixel chromaticity).

Employing the data in Tables 1, 2 and 3, and using the method of the present invention as described above, the relative proportions for the light-emitting elements were calculated to be approximately, 0.151, 0.251, 0.0167 and 0.431 for the red, green, blue and white light-emitting elements respectively, where the total area of the pixel is 1. That is, the area ratio of red:green:blue:white light-emitting elements is 1:1.7:1.1:2.9. In addition, the expected time for the red, green, blue and white light-emitting elements to produce half their initial luminance are 69186, 69217, 69064 and 69372 hours, respectively. This method provides a display lifetime of 69,064 hours (i.e., the minimum of the individual color half-life values).

Notice that because the probability of near neutral colors, which is near the color of the white emitting element, this light-emitting element is larger than the red, green, or blue light-emitting elements. However, the red, green and blue light-emitting elements have a finite size and a projected lifetime that is approximately equivalent to the white light-emitting element. It is likely that in most display applications, there will be a preponderance of neutral colors since most of today's graphical user interfaces tend to predominantly employ windows having white or neutral backgrounds and images tend to have more near-neutral than saturated colors. Therefore, in any display device having a white light-emitting element, such element is likely to be larger than the red, green, and blue light-emitting elements, a configuration that is not demonstrated in the prior art.

### EXAMPLE 2

### Comparative

Using a conventional display of the prior art having equal sized red, green, blue and white light-emitting elements, the expected lifetime for the red, green, blue, and white light-emitting elements are 159200, 68620, 130417, and 23310 hours respectively. Notice that the shortest lifetime for any single emitter exists for the white light emitting element, which has a lifetime of 23,310 hours. Therefore the overall lifetime of the display device while employing all four light-emitting elements is 23,310 hours as compared to 69,034 hours obtained employing the method of the current invention.

### EXAMPLE 3

### Comparative

In this example a conventional display of the prior art is modeled by applying knowledge of the display structure, the chromaticity and luminance of the white point, efficiency, and material stability over time as discussed by U.S. Pat. No. 6,747,618 issued Jun. 8, 2004 to Arnold, et al, without considering the display usage profile information. To produce this example, it is assumed that the display device should be driven to produce a full white field. Applying this method and assumption produces a display with light-emitting element areas of 0.215, 0.058 and 0.727 for the green, blue and white, respectively, and no red light-emitting element. The expected time for the green, blue and white light-emitting elements to produce half their initial luminance are 53530, 12120 and 163980 hours, respectively. The resulting display device, however, would have a practical lifetime of 0 hours since the red light-emitting element is not present and therefore the display can not be illuminated to provide a full-color image.

Thus it can be readily seen the method of the present invention provides a substantial improvement in the useful lifetime of the display over having a display device with equal area light-emitting elements and is further advantaged over methods that assume that lifetime can be optimized by determining the relative areas such that the lifetime of a display that presents only the peak white luminance of the display device.

The invention has been described in detail with particular reference to certain preferred embodiments thereof, but it will be understood that variations and modifications can be effected within the spirit and scope of the invention.

### PARTS LIST

10 OLED display device
12 pixel
14R red light-emitting element
14G green light-emitting element
14B blue light-emitting element
14W white light-emitting element
20 determine chromaticity coordinates step
22 determine display usage profile step
24 enumerate step
26 calculate joint probabilities step
28 calculate aim luminance step
30 determine optical transmission factor step
32 calculate luminance value after optical transmission step
34 select fill factor step
36 calculate luminance for light-emitting element step
38 enter characteristic curves step
40 calculate aim current density step
42 determine luminance stability over time step
44 calculate useful lifetime step
46 calculate overall lifetime step
48 decision step
50 modify step
52 complete process step
60 substrate
62 anode layer
64 hole-injecting layer
66 hole-transporting layer
68 light-emitting layer
70 electron-transporting layer
72 cathode
80 display device
82 first area
84 second area
86B blue light-emitting element in first area
86R red light-emitting element in first area
86G green light-emitting element in first area
86W white light-emitting element in first area
88R red light-emitting element in second area
88G green light-emitting element in second area
88B blue light-emitting element in second area
88W white light-emitting element in second area
90 efficiency curve for white light-emitting element
92 efficiency curve for green light-emitting element
94 efficiency curve for red light-emitting element
96 efficiency curve for blue light-emitting element
98 luminance stability characteristic curve
100 neutral color
102 saturated red color
104 saturated green color
106 saturated blue color

1. An improved OLED color display device, in which a display pixel has a plurality of light-emitting elements of different colors, wherein the areas of the light-emitting elements are different based on the emission efficiency of the light-emitting elements and the luminance stability over time of the light-emitting elements, thereby protecting the light-emitting elements whose emission efficiency or luminance stability is low from prematurely deteriorating, wherein the improvement comprises:
the relative areas of the light-emitting elements being further based on a display usage profile including probabilities of different colors to be produced on the display during its lifetime, thereby further extending the useful lifetime of the display.

2. The color display device claimed in claim 1, wherein the display device has three different colored light-emitting elements that emit red, green and blue light.

3. The color display device claimed in claim 1, wherein the display device has four or more different colored light-emitting elements.

4. The color display device claimed in claim 3, wherein the four or more different colored light-emitting elements include red, green, and blue light-emitting elements and at least one additional light-emitting element selected from white, yellow, cyan, and magenta light-emitting elements.

5. The color display device claimed in claim 4, wherein the area of the additional light-emitting element is substantially larger than the area of at least one of the red, green and blue light-emitting element to compensate for the increased usage of the additional light-emitting element as compared to one or more of the red, green and blue light-emitting elements.

6. The color display device claimed in claim 1, wherein the display sage profile additionally comprises one or more of the set including peak white luminance values with a probability of occurrence for each value, one or more display white points with a probability of occurrence for each value, the code values the display will be driven to with their respective probabilities, and a model that provides a conversion from code value to aim display luminance and parameter values used in the conversion process with a probability of occurrence for each parameter value.

7. The color display claimed in claim 1, wherein one or more of the light emitting elements comprises at least two light-emitting layers stacked on top of one another.

8. The color display claimed in claim 1, wherein two or more of the light emitting elements are stacked on each other.

9. The color display claimed in claim 1, comprising a greater number of light-emitting elements of one color than of at least one other color.

10. The color display claimed in claim 1, wherein the relative areas of the light-emitting elements are different at different spatial locations on the display device.

11. A method of determining the relative areas of light-emitting elements in a OLED display device of the type having a display pixel that includes a plurality of light-emitting elements of different colors, comprising the steps of:
a) determining a functional relationship between current density and luminance output for each light-emitting element;
b) determining a functional relationship between current density and a luminance stability over time for each light-emitting element;
c) determining a display usage profile for the display device including probabilities of different colors to be produced on the display during its lifetime;
d) selecting an initial relative light emissive area for each color of light-emitting element;
e) calculating a required luminance for each color of light-emitting element for each color within the display usage profile;
f) calculating an aim current density for each light-emitting element for each color within the display usage profile to obtain the required luminance for each light-emitting element;
g) calculating a lifetime for each light-emitting element for each color within the display usage profile using the aim current density and the luminance stability functions;
h) calculating an overall lifetime for each colored light-emitting element based on the lifetime and probability for each color in the profile; and
i) modifying the relative light emissive areas for each color of the light-emitting elements if the overall lifetimes are unequal, and repeating steps e, f, g, and h until the lifetimes are substantially equal.

12. The method claimed in claim 11, wherein the display device has three different colored light-emitting elements that emit red, green and blue light.

13. The method claimed in claim 11, wherein the display device has four or more different colored light-emitting elements.

14. The method claimed in claim 13, wherein the four or more different colored light-emitting elements include red, green, and blue light-emitting elements and at least one additional light-emitting element selected from white, yellow, cyan, and magenta light-emitting elements.

15. The method claimed in claim 11, wherein the display usage profile additionally comprises one or more of the set including peak white luminance values with a probability of occurrence for each value, one or more display white points with a probability of occurrence for each value, the code values the display will be driven to with their respective probabilities, and a model that provides a conversion from code value to aim display luminance and parameter values used in the conversion process with a probability of occurrence for each parameter value.

16. The method claimed in claim 11, further comprising sizing individual light-emitting elements so as to provide a greater number of light-emitting elements of one color than at least one other color.

17. The method claimed in claim 11, wherein the display usage profile is different at different spatial locations on the display device, and further comprising sizing the relative areas of the light-emitting elements differently at different spatial locations on the display device.
